(19) United States
(12) Patent Application Publication
(10) Pub. No.: US 2004/0238994 A1
(43) Pub. Date: Dec. 2, 2004

(54) Method of manufacturing a fin

(76) Inventor: Ching-Wen Wang, San Chung City (TW)

Correspondence Address: RABIN & BERDO, P.C., Suite 500, 1101 14th Street, N.W., Washington, DC, 20005, US

(21) Appl. No.: 10/446,071

(22) Filed: May 28, 2003

(51) Int. Cl. B29C 45/16

(52) U.S. Cl. 264/161; 264/255; 264/328.8

(57) ABSTRACT

A fin is formed using a set of sectional molds, in which two material injecting units are provided to simultaneously inject two different types of raw materials into the molds, so that a blade portion and a foot pocket portion of the fin are formed at the instant of injection to produce a complete fin. The two injecting units may be separately preset or adjusted to optimal injecting time and pressure according to flow rates of the two types of raw materials in molten state, so that the molded blade portion and foot pocket portion are fully connected together to have an optimal bonding strength between them.

### FIELD OF THE INVENTION

The present invention relates to a method of manufacturing a fin, and more particularly to a method for molding a blade portion and a foot pocket portion of a fin by injecting their respective materials simultaneously to obtain an optimal bonding strength between the two portions and well controlled colors for the fin manufactured in the method of the present invention.

### BACKGROUND OF THE INVENTION

FIG. 1 is a perspective view of a typical fin 4 including a blade portion 41 for kicking water and a foot pocket portion 42 for a diver's foot to wear. The blade portion 41 requires a certain degree of rigidity to allow effective kicking under water and is preferably made of a relatively hard material. On the other hand, the foot pocket portion 42 is preferably made of a relatively soft and flexible material to allow active movements of the diver's foot without causing an injured ankle.

Two major types of material for making fins are plastic and rubber materials. A fin made of a plastic material is considerably solid and durable for use but less tensile for wearing easily. On the other hand, a fin made of a rubber material has a relatively good tensile strength and is therefore more comfortable for wearing. A major disadvantage of the rubber fin is the high material cost. With the largely upgraded injection molding technique, the problems with plastic fins, such as uncomfortable for wearing and uneasy to move under water, have been gradually overcome. Currently, there are two molding methods for manufacturing fins using two different types of raw materials in consideration of the functions of different portions of the fins and the comfort in wearing the fins.

FIGS. 4A to 4D illustrate the first conventional method of manufacturing a fin using rubber materials. As it is known, rubber is a thermosetting material. To manufacture an article with rubber materials through molding, soft and hard rubber masses that are not thermally set are positioned in a mold cavity under a high temperature of 180° C. to combine together through a series of chemical changes, including curing, thermosetting, cross-linking, and bridging. That is, the mold is opened without the cooling process. An advantage of this manufacturing method is a high bonding strength between the soft and the hard rubber materials can be obtained.

In the first conventional method for manufacturing a fin shown in FIGS. 4A to 4D, a lower mold half 50 providing a lower mold cavity 52 and an upper mold half 51 providing an upper mold cavity 53 are used. To manufacture the fin 4 shown in FIG. 1, a first raw material 8 having a relatively high hardness and in a semi-solid state is supplied into the molding cavities 52, 53 at a position for forming the blade portion 41 of the fin 4, and a second raw material 9 having a predetermined softness and elasticity is supplied into the molding cavities 52, 53 at a position for forming the foot pocket portion 42 of the fin 4, as shown in FIG. 4A. Then, the lower and the upper mold half 50, 51 are closed, as shown in FIG. 4B, so that the first and the second raw material 8, 9 having different properties and in the semi-solid state are joined together. After the joined raw materials 8, 9 are molded and cured, a finished product of fin 4 is formed, as shown in FIG. 4C. The lower and the upper mold half 50, 51 are then opened to remove the molded fin 4 from the mold cavity, as shown in FIG. 4D.

FIGS. 5A to 5F illustrate the second conventional method for manufacturing a fin 4. In this second method, a first and a second set of sectional molds are used to mold the fin 4. The first set of sectional molds include a first lower mold half 60 and a first upper mold half 61 that together define a first mold cavity 62 between them for forming a blade portion 41 of the fin 4. A first material injecting unit 64 is provided at a predetermined position below the first lower mold half 60 for smoothly injecting a first raw material 8 having a predetermined hardness into the first mold cavity 62 via a first injection port 63, as shown in FIG. 5A. Aafter the first lower and upper mold halves 60, 61 are closed and the first raw material 8 is injected into the mold cavity 62, allow the first set of sectional molds in the closed state to cool. After the first sectional molds are cooled, they are opened and the molded blade portion 41 of the fin 4 is removed from the mold cavity 62, as shown in FIG. 5B. A small part of the injected first raw material 8 is molded in the first injection port 63 to form a first molded head 65, as shown in FIG. 5B. After the first molded head 65 is trimmed off, a blade portion 41 of the fin 4 is finished, as shown in FIG. 5C. The finished blade portion 41 is then moved to the second set of sectional molds.

Please refer to FIG. 5D. The second set of sectional molds include a second lower mold half 70 and a second upper mold half 71 that together define a second mold cavity 72 for forming a complete fin 4. The finished blade portion 41 of the fin 4 is duly positioned in the second mold cavity 72. A second injection port 73 is provided on the second lower mold half 70 to communicate with an area in the second mold cavity 72 for molding the foot pocket portion 42 of the fin 4. After the second lower and upper mold halves 70, 71 are closed, a second raw material 9 having predetermined softness and elasticity is injected from a second material injecting unit 74 into the second mold cavity 72 via the second injection port 73 to well bond with the molded blade portion 41 positioned in the second mold cavity 72, as shown in FIG. 5E. After the second set of sectional molds are cooled and opened, a half-finished product of fin 4 having a second molded head 75 is removed from the second mold cavity 72, as shown in FIG. 5F. The second molded head 75 is then trimmed off and a finished product of the fin 4 is obtained.

Taiwan Patent published under No. 339265 discloses a process of manufacturing an injection-molded multi-density midsole. In this patented process, a mold for forming the midsole is connected to at least two material feeding channels. By regulating different injection conditions, including injection pressure, injection rate, injection shot, and injection time difference, different but mutually soluble raw materials, such as PP, TPU, nylon, etc., may be simultaneously injected via the material feeding channels into the mold. The materials are mutually solved in the mold to form an integrally molded midsole. Different raw materials of specific hardness and elasticity may be used to mold front and rear portions of the midsole depending on use of the midsole on different types of shoes.

Following disadvantages are found in the first and the second conventional method of manufacturing a fin:

1. In the first conventional method, since the raw materials are supplied into an open mold cavity, an increase allowance for molding material is required to avoid production of a defective product due to insufficient molding material. On the other hand, the increased allowance for molding material results in burrs and accordingly increased cost for trimming off the burrs. Meanwhile, the raw material for molding the fin must be a type of thermosetting material that requires a series of chemical changes to complete the processing cycle over a quite long time about 4 to 5 times of the injection time. Moreover, the volume of injected raw materials and the positioning thereof makes the manufacturing process very complicate, and the sectional molds have an operating temperature as high as 180° C. that requires an experienced and skilled person to handle and therefore could not be advantageously mass-produced at reduced cost. It is also difficult to control the colors and properties of the finished product due to the chemical changes of the raw materials during the molding process.

2. In the case a dual-color injection-molding machine is employed to produce the fin, the costs for the molding machine and molds are extremely high. When two sets of molds are used, an oil press for moving molds backward is required to enable change of injection from one set of molds to the other set of molds. And, to enable the two sets of molds to automatically turn over immediately after each injection, a moldboard turning means for mold locking mechanism is required. Under these conditions, the first conventional method for molding a fin requires a mold cost about 4 times higher and a molding machine cost about 2 to 3 times higher than that required by a general injection-molding machine. There are still other special parts and components for the molding machine that all are very expensive. Therefore, the first conventional method for manufacturing the fin is not industrially practical and valuable for use.

3. In the second conventional method for manufacturing the fin, the blade portion of the fin is first molded in a first set of sectional molds and then positioned into a second set of sectional molds to complete the fin. It is possible the blade portion molded with the first set of molds is not well trimmed to remove the molded head before being positioned in the second set of molds. And, it is doubtful whether the blade portion and foot pocket portion are well aligned as desired in the second set of molds, and this could be visually checked only when the second time molding is completed and the second set of molds are opened.

4. In the second conventional method for manufacturing the fin, the blade portion molded with the first set of molds is positioned into the second set of molds in a solid state while the raw material supplied into the second set of molds for forming the foot pocket portion is semi-liquid. It is not sure whether a sufficient bonding strength at an interface between the two portions may be obtained.

5. In the second conventional method for manufacturing the fin, the first and the second molded head on the separately molded blade portion and foot pocket portion are trimmed off in two movements at different time, making it difficult to arrange a smooth and efficient production line for manufacturing the fin.

As to the method disclosed in Taiwan Patent Pub. No. 339265, it is subject to many limits, such as using mutually soluble raw materials. Moreover, the method is applied only to the manufacture of a midsole.

### SUMMARY OF THE INVENTION

It is therefore a primary object of the present invention to eliminate the drawbacks existed in the conventional methods of manufacturing a fin by providing an improved method that employs simplified molding equipment to manufacture a fin at reduced cost while the fin produced in the method of the present invention has good bonding strength between a blade and a foot pocket portion thereof and well controllable colors.

To achieve the above and other objects, the method of the present invention employs one single set of sectional molds consisting of a lower mold half having a lower mold cavity and an upper mold half having an upper mold cavity. The lower mold half is provided at a joint with the upper mold half with a first and a second injection port corresponding to areas of the lower mold cavity for forming a blade portion and a foot pocket portion of a fin, respectively. A first and a second material injecting unit are aligned with the first and the second injection port, respectively, to inject two different types of molten raw materials for the blade and the foot pocket portion at well adjusted injection time and pressure depending on the respective flow rates of the two types of raw materials, so that the raw materials are simultaneously injected to integrally mold the blade portion and the foot pocket portion at the same time within a predetermined duration, enabling the blade portion and the foot pocket portion to integrate into one body and have an optimal bonding strength between the two portions.

In the method of the present invention, the molding equipment maybe obtained at largely reduced cost simply by providing one more material injecting unit on a conventional injection-molding machine.

In the method of the present invention, the provision of two material injecting units and two injection ports enables injection of two different types of raw materials for the blade and the foot pocket portion that function differently and therefore require different hardness. Moreover, the two different raw materials may be differently colored for the molded fin to have differently colored blade portion and foot pocket portion and therefore appealing appearance.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a finished product of fin manufactured in a method according to the present invention;

FIGS. 2A to 2C illustrate different steps of forming a fin with sectional molds in the method of the present invention;

FIGS. 3A to 3C are bar charts showing test data obtained from different methods of manufacturing fins;

FIGS. 4A to 4D illustrate different steps of forming a fin in a first conventional method; and

FIGS. 5A to 5F illustrate different steps of forming a fin in a second conventional method.

### DETAILED DESCRIPTION OF THE PREFERRED EMBODIMENTS

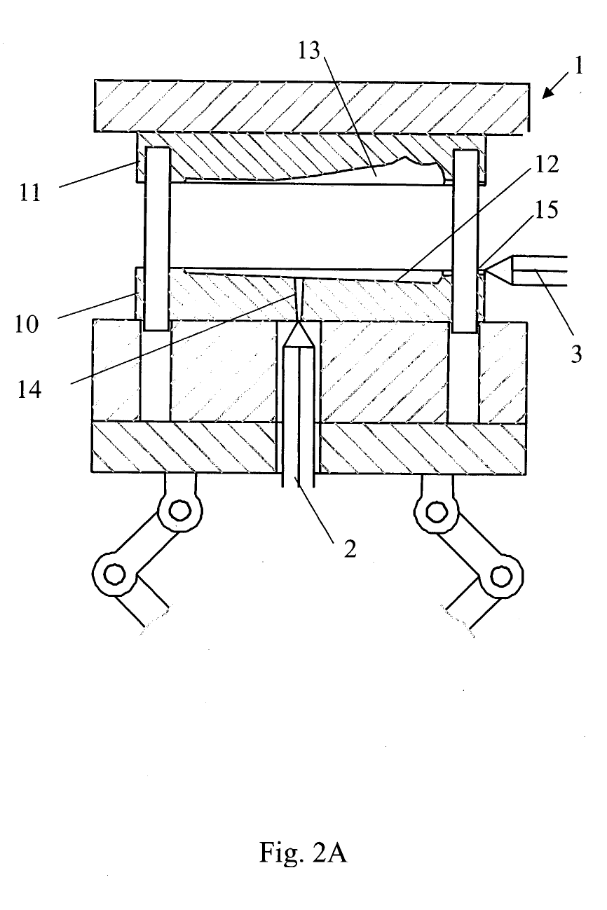

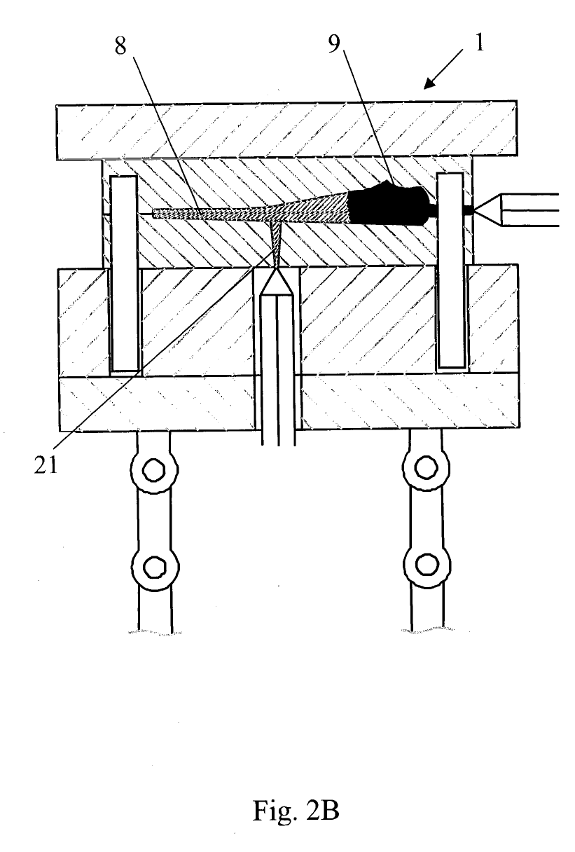

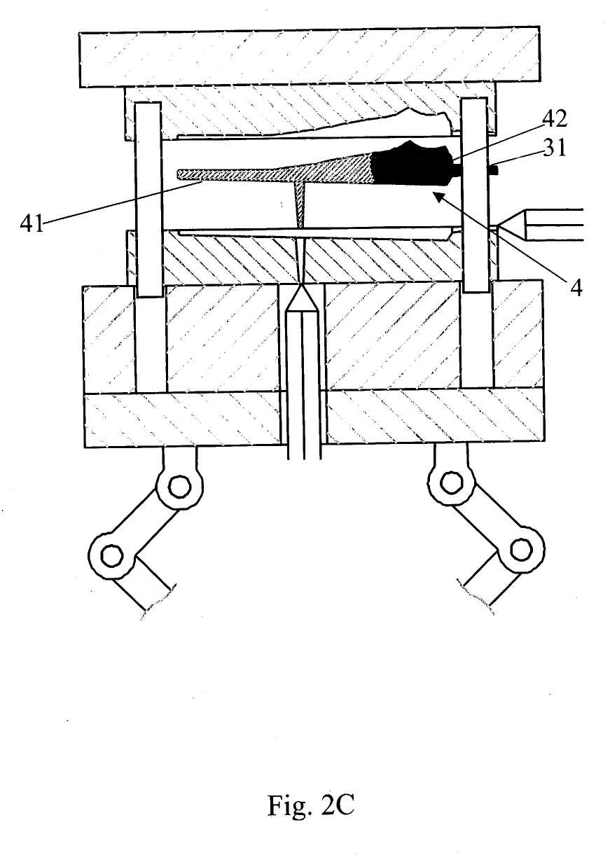

Please refer to FIGS. 2A to 2C that illustrate the forming of an injection-molded fin 4 in the method of the present invention. As shown, an injection-molding machine employed to implement the method of the present invention is a set of sectional molds 1 including a stationary lower mold half 10 having a lower mold cavity 12 and a reciprocatingly movable upper mold half 11 having an upper mold cavity 13. The lower and the upper mold cavity 12, 13 together form a mold cavity for molding a complete fin 4 having a blade portion 41 and a foot pocket portion 42. A downward tapered through opening serving as a first injection port 14 is provided on the lower mold half 10 within an area of the lower cavity 12 corresponding to the blade portion 41 of the fin 4 to be molded with the set of sectional molds 1. A second injection port 15 is provided at a mold joint of the lower and the upper mold half 10, 11 to communicate with areas of the mold cavities 12, 13 at where the foot pocket portion 42 of the fin 4 is molded. When the lower and the upper mold half 10, 11 of the sectional molds 1 are closed and moved into a predetermined position for injection, the first injection port 14 is aligned with and closely connected to a first material injecting unit 2, and the second injection port 15 is aligned with and closely connected to a second material injecting unit 3. A first type of raw material 8 having a relatively high hardness for forming the blade portion 41 is loaded in the first material injecting unit 2, and a second type of raw material 9 having a relatively high softness and elasticity for forming the foot pocket portion 42 is loaded in the second material injecting unit 3.

A first step of the method of the present invention for molding the fin 4 is shown in FIG. 2A. The reciprocatingly movable upper mold half 11 is pushed toward the lower mold half 10 to complete closing of the sectional molds 1. Thereafter, the first and the second material injecting unit 2, 3 are moved forward to align with and closely connect to the first and the second injection port 14, 15, respectively.

A second step of the method of the present invention is shown in FIG. 2B. The first and the second material injecting unit 2, 3 are simultaneously actuated to inject the two types of raw materials 8, 9 for injection-molding the blade portion 41 and the foot pocket portion 42 at the same time. Since the raw materials 8, 9 are different types of materials, they have different flow rates in the semi-liquid molten state. To enable injection of the two types of raw materials to complete at the same time, the first and the second material injecting unit 2, 3 are independently regulated in advance to the required injection pressure. After completion of the injection, the area in the mold cavity of the closed sectional molds 1 for forming the blade portion 41 of the fin 4 is filled with the first raw material 8, and the area for forming the foot pocket portion 42 of the fin 4 is filled with the second raw material 9. Since the two types of raw materials are injected into and bond together in the closed mold cavity 12, 13 when they are in the semi-liquid molten state, they are tightly joined at an interface between them to ensure an optimal bonding strength between the blade portion 41 and the foot pocket portion 42 and accordingly an extended usable life of the finished product of fin 4.

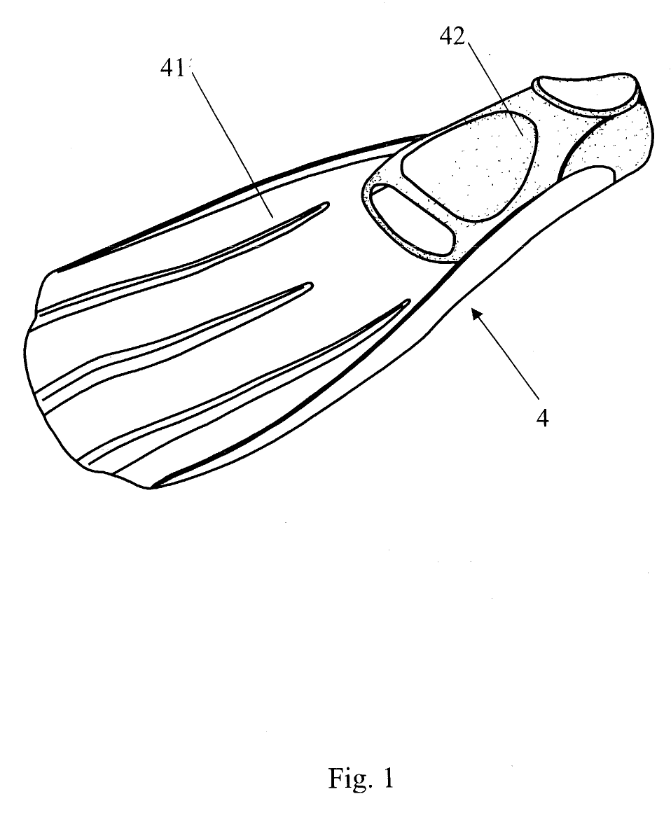

A third step of the method of the present invention is shown in FIG. 2C. After the molding materials 8, 9 have become cool, the sectional modes 1 are opened by upward moving the upper mold half 11 from the lower mold half 10, and the half-finished molded product having a first molded head 21 and a second molded head 31 due to the injection ports 14, 15 is removed from the sectional molds 1. The molded heads 21, 31 are then trimmed off to obtain the finished product of fin 4 shown in FIG. 1.

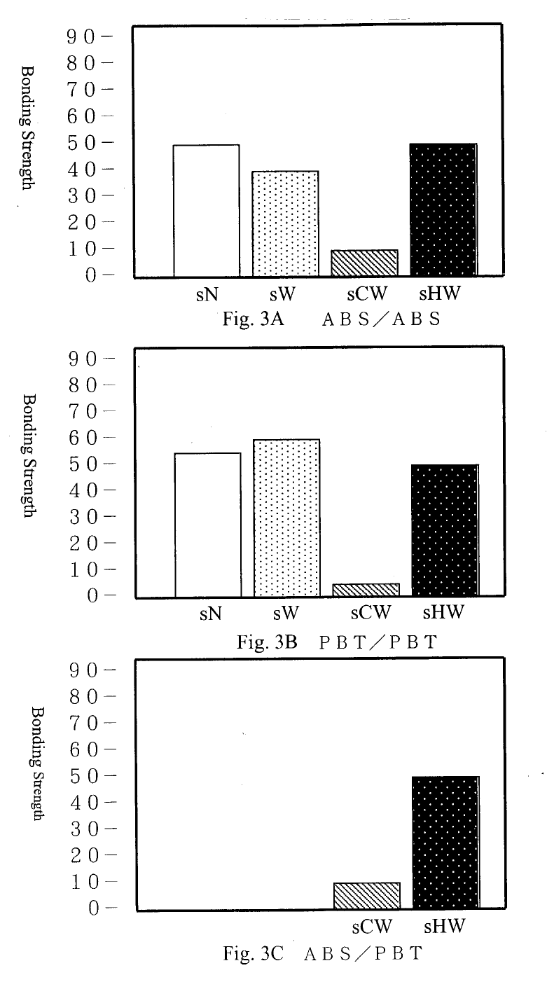

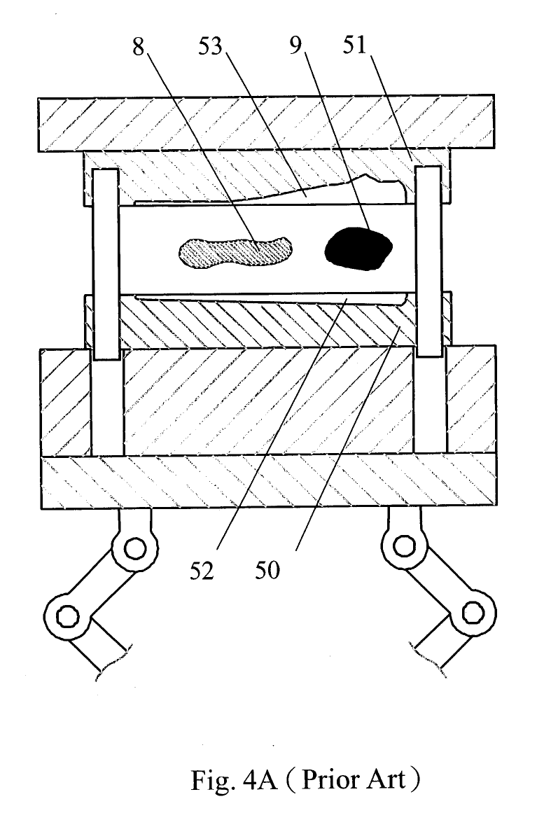

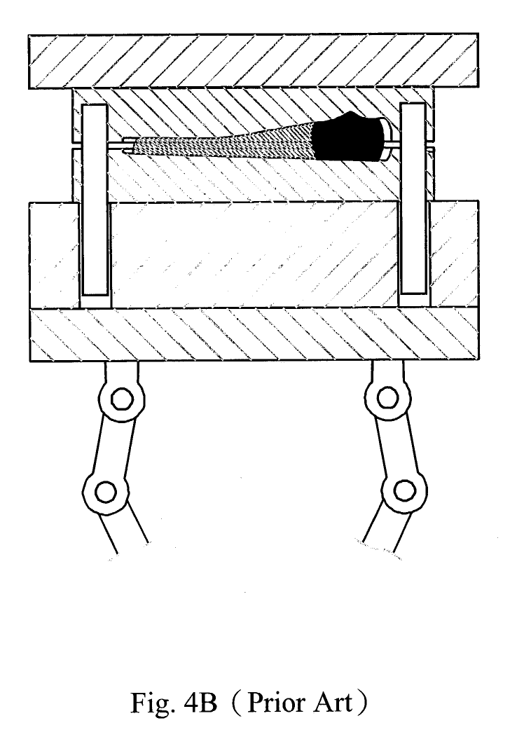

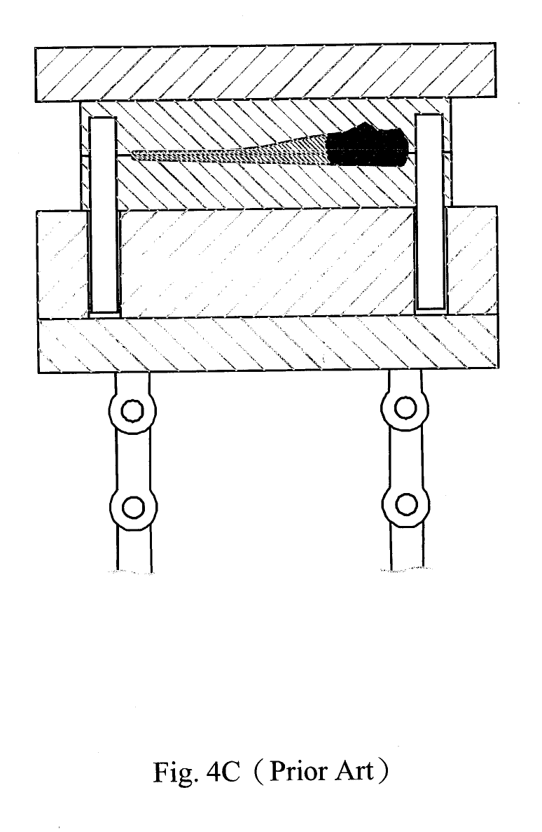

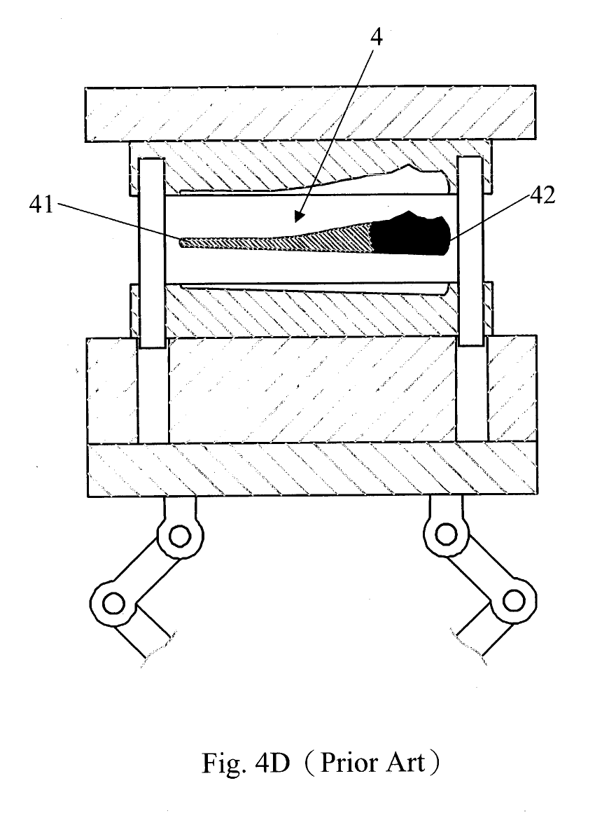

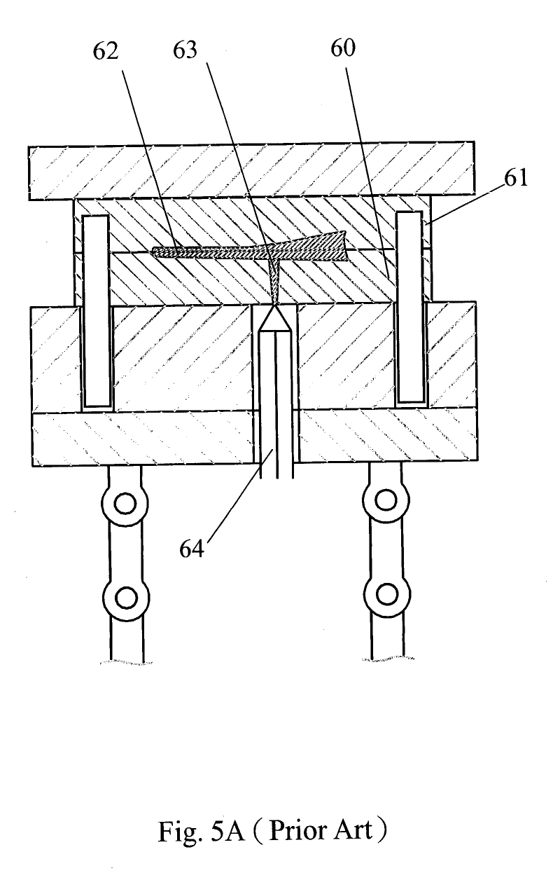

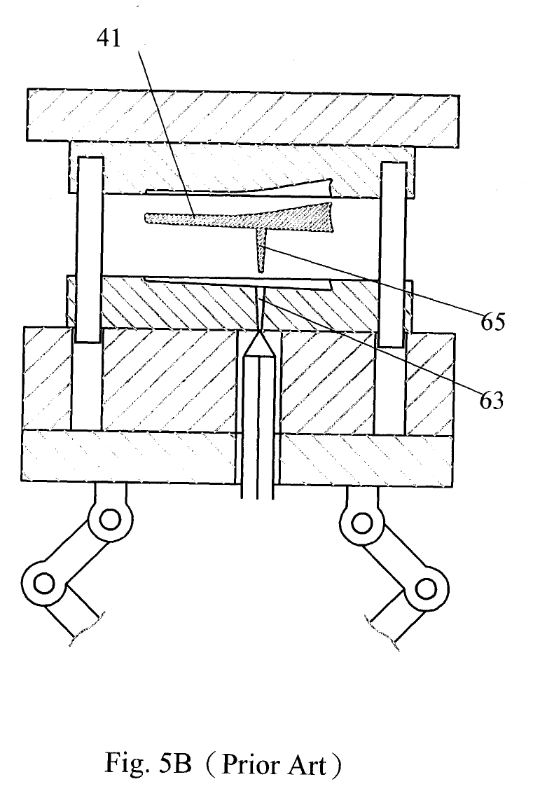

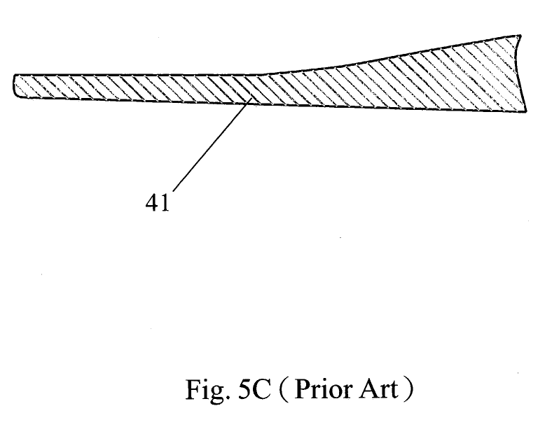

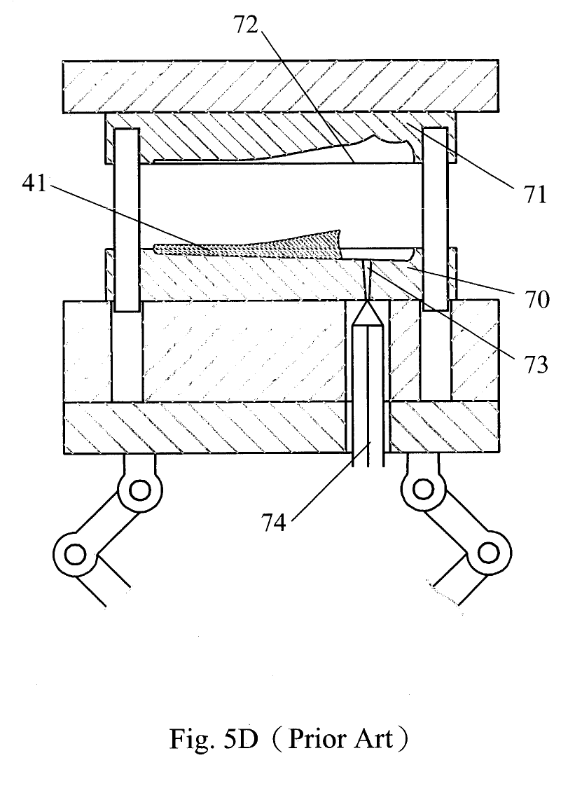

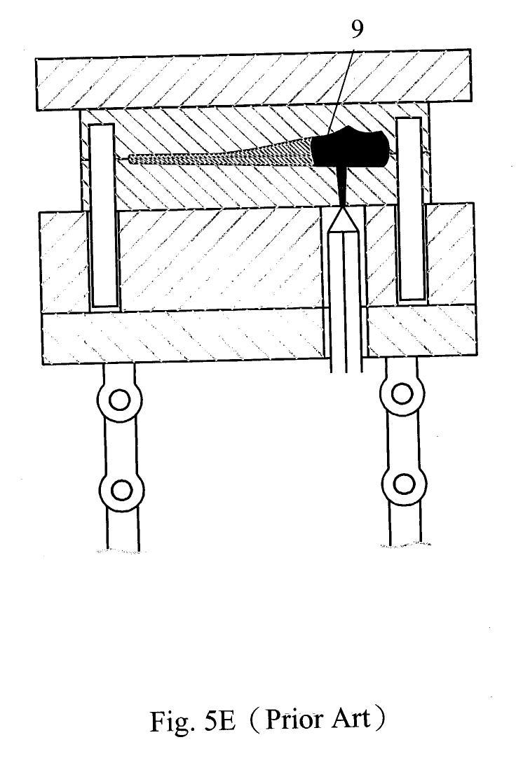

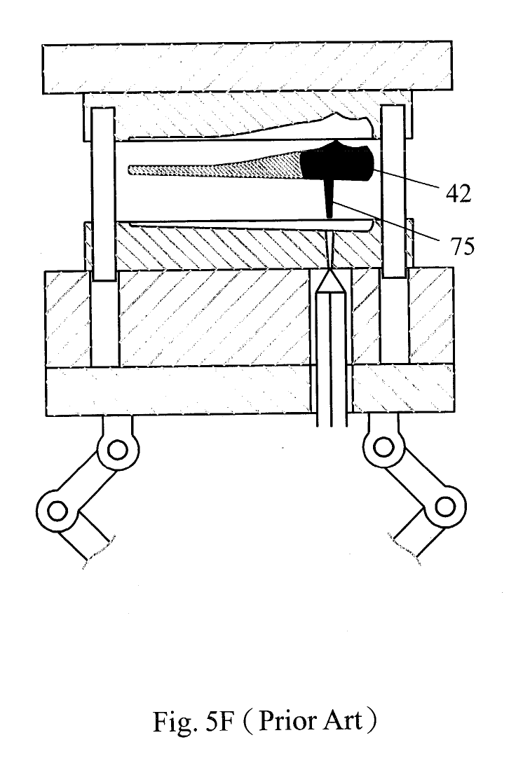

The technical principles adopted by the present invention and the bonding strength of the fin molded in the method of the present invention will now be explained as below with reference to data shown in FIGS. 3A to 3C as bar charts. FIGS. 3A and 3B separately show strength data of two products, both of which are injection-molded with two different materials. And FIG. 3C shows strength data of a product obtained with one mold through injecting two different materials at the same time. In FIGS. 3A to 3C, sN represents a tensile strength, sW represents a strength at melt run, sCW represents a halved joint strength, and sHW represents a combined bonding strength.

Data shown in FIG. 3A are based on a finished product manufactured in the second conventional method. As shown, the product has a halved joint strength sCW of about 10 Mpa, which is only ⅕ of the inherent tensile strength sN of the raw materials. Data shown in FIG. 3B indicate the product also manufactured in the second conventional method has a halved joint strength sCW of about 5 Mpa, which is only 1/10 of the inherent tensile strength sN of the raw materials. From FIGS. 3A and 3B, it can be seen that, with the second conventional method for molding a fin in two injections, there is not molecular entanglement occurred between the first molded blade portion and the molten resin for molding the foot pocket portion, and therefore the two portions of the injection-molded fin has a low bonding strength between them. However, when two types of raw materials are injected at the same time in the method of the present invention, the injection-molded fin has a bonding strength sHW about 30 Mpa, which is three times of the halved joint strength sCW of the fin shown in FIG. 3A. This is because the two different raw materials are combined when they are in the molten state, and it is possible to set an interfacial pressure for the two types of raw materials independently, so as to optimize the injection-molding process.

In brief, in the method of manufacturing a fin according to the present invention, the blade portion and the foot pocket portion of the fin are formed through injecting two different molding materials at the same time and have the optimized bonding strength between them. Moreover, the method of the present invention allows good control of colors for the two portions of the fin, and employment of low-cost injection-molding equipment enabling mass production.

The present invention has been described with a preferred embodiment thereof and it is understood that many changes and modifications in the described embodiment can be carried out without departing from the scope and the spirit of the invention as defined by the appended claims.

What is claimed is:

1. A method of manufacturing a fin, comprising the steps of:
Preparing a set of sectional molds consisting of a stationary lower mold half having a lower mold cavity, and a reciprocatingly movable upper mold half having an upper mold cavity, said lower and said upper mold cavity together defining a mold cavity for injection molding a blade portion and a foot pocket portion of said fin at the same time; a first injection port being provided on said lower mold half within an area of said lower mold cavity for forming said blade portion, and a second injection port being provided at a mold joint of said lower and said upper mold half to communicate with an area of said mold cavity at where said foot pocket portion is to be injection-molded; and a first and a second material injecting unit having two different types of molding materials loaded therein being located close to said first and said second injection port, respectively;
and said first and second material injecting units being independently adjustable in injection time and pressure thereof;
moving said upper mold half toward said lower mold half to close said set of sectional molds;
moving said first and said second material injecting unit for them to align with and closely connect to said first and said second injection port, respectively;
injecting said molding materials loaded in said first and second material injecting units into said mold cavity via said first and second injection ports, so that said two different types of molding materials are filled into predetermined positions and integrated into one injection-molded body of said fin in said mold cavity;
moving said upper mold half away from said lower mold half to open said set of sectional molds;
removing said integrated body of said fin from said mold cavity; and
trimming off molded heads formed at said first and said second injection ports to obtain a finished product of said injection-molded fin.

2. The method of manufacturing a fin as claimed in claim 1, wherein said two types of molding materials are differently colored.
